(19) United States
(12) Patent Application Publication
(10) Pub. No.: US 2021/0286988 A1
(43) Pub. Date: Sep. 16, 2021

(54) COMPUTER-IMPLEMENTED METHOD FOR DETECTING DOCUMENT CONTENT FROM A DOCUMENT

(71) Applicants: Claus EICHMANN, Hattersheim (DE); OAHIKI AG, Frankfurt am Main (DE)

(72) Inventor: Claus EICHMANN, Hattersheim (DE)

(21) Appl. No.: 17/263,635

(22) PCT Filed: Jul. 31, 2018
(86) PCT No.: PCT/EP2018/070805

§ 371 Date: Jan. 27, 2021

(51) Int. Cl. G06K 9/00

(52) U.S. Cl. CPC G06K 9/00442; G06K 2209/01

(57) ABSTRACT

The invention relates to a computer-implemented method for detecting document content from a document, said method detecting information from the document based on generic rules and assigning said information to parameters. A general document type or specific document type is determined on this basis, wherein the general document type has general rules for assigning further information to parameters, and the specific document type has specific rules for determining and assigning further information to parameters. A calculated and/or isolated reliability value is provided for each assignment of information.

The invention relates to a computer-implemented method for the (partially) automated acquisition of document content from a document. Document content relevant to the method is in this case intended to be acquired in particular for further processing, such as for example, in the case of invoicing, information about an invoice issuer or client, an amount containing currency information, a possible payment term and categorization(s).

A document in this sense is a digitally readable image of a document in an electronic file standardized in terms of format, content and structure, similar to for example “.docx” for Microsoft Word documents. All documents to be processed are initially transferred to this standardized format. Documents may in this case comprise one or more pages and contain any elements (for example text, graphics, tables).

In order to process documents from any sources and in any formats, the documents often have to be prepared. Documents that are initially available only in analog form, for example on paper, may be scanned in a first step and thus converted into a digital image (for example JPG, GIF, PNG, PDF or TIFF). Digital images from any sources (for example scan, screenshot) may be supplied to a text recognition system (OCR) in a further method step, which extracts text, characters, formatting as well as possibly graphical elements and physical properties of the digital image and stores them in a digitally readable form (for example TXT, DOC, HTML, RTF, XLS). This gives a digital document that is able to be further processed by way of computer-implemented methods.

The commercially available computer-implemented methods for acquiring document content are designed for processing documents that are known per se in advance. For this purpose, systems based on artificial intelligence (AI) use a large number of sample documents that comprise both positive samples and possibly also negative samples such as forgeries to learn typical characteristics or patterns in these documents and the relevant information contained therein.

However, it generally makes sense to use these methods only if the supplied documents are known per se in advance and the system has already used a large number of sample documents to learn characteristics corresponding to the document.

The known methods are therefore hardly suitable for processing a very large number of different documents and are not capable of successfully processing completely unknown documents.

A further disadvantage of known methods for acquiring document content is also very often the lack of “anticipation” of information to be identified and its properties. This makes it problematic to locate this information and to verify an achieved result or to rate its reliability—without such systematic rating of the reliability of extracted information, however, it is not possible to make a general statement about the correctness of the acquired document content and the quality achieved in the process, but it is precisely this that is a mandatory requirement for the efficient further (partially) automated processing of the method on which the document is based.

The invention is then based on the object of providing a computer-implemented method that makes it possible to acquire document content relevant to the method even from unknown documents, without the need for a large number of previously read-in sample documents. The system should furthermore be capable of identifying whether documents that are similar in terms of form, for example using an identical format template, have already been processed, and thereby of continuously improving the acquisition of the document content relevant to the method. The system should in this case remain efficient without any limitations even during decentralized use without the exchange of sensitive personal data, that is to say any transfer of original documents containing personal information is at least not technically mandatory. This object is achieved by a method having the features of claim 1. Advantageous refinements may be found in the dependent claims.

According to the invention, in a computer-implemented method for acquiring document content from a document on the basis of generic rules, information is acquired from the document and assigned to parameters and a general document type or specific document type is ascertained on this basis, wherein the general document type has general rules for assigning further information to parameters and the specific document type provides specific rules for ascertaining and assigning further information to parameters, wherein the general document type is selected if no suitable specific document type is able to be ascertained, wherein the respective assignment of information to a parameter is given a calculated and/or isolated reliability value.

Based on generic rules, the method according to the invention, in a first step, assigns the document to be processed to a general or specific document type. A general document type is for example an invoice, a contract, a letter, a note or the like, for which no precedent has yet been acquired. The general document type comprises general rules for determining the information relevant to the method, using which the candidate representing the desired information for a parameter is selected and assigned from possible candidates present in the document.

If a precedent already exists, that is to say a document corresponding in terms of form to the document to be processed, for example using an identical form/template, has already been processed at an earlier point in time, a specific document type may be selected. Each specific document type, such as for example an invoice from a specific consignor, a contract from a specific contractual partner, etc. is assigned specific rules for determining the information relevant to the method.

The term “rules” should be understood here in each case to mean a policy that contains multiple sets of rules in each case for individual parameters defined in the document type, wherein each set of rules consists of multiple individual rules, wherein each individual rule acquires a certain property of a parameter and also an expected value or range of values that this property assumes for this parameter in a document type. The comparison between this expected range of values and the actually ascertained value for a candidate of this parameter in a new document then makes it possible, taking into account all other relevant rules and comparisons, to ascertain a reliability value and thus a rating of the reliability with which a certain candidate actually contains the correct information for a parameter.

This method may be used to acquire the content of any provided document by ascertaining a general or specific document type suitable for this document and then applying the rules stored there.

The information is preferably in this case ascertained from one or more candidates identified in the document, wherein an isolated reliability value for each candidate is ascertained on the basis of the general and/or specific rules. In the method according to the invention, the entire document is thus searched for suitable candidates that could represent the corresponding information. There is then a check on the extent to which the corresponding general or specific rules that the selected document type provides for ascertaining the information and assigning it to the parameter are met. By way of example, by comparing the expected result of the rule with the actual result of the rule, that is to say the information assigned to a parameter, it is possible to ascertain an isolated reliability value for each candidate found in the document that could represent the desired information for a parameter. The reliability value in this case represents a probability of the candidate actually corresponding to the information relevant to the method that is sought for the respective parameter. If this results in a high reliability value for a candidate, this has a high probability of representing the sought information, and is accordingly assigned to the respective parameter.

A calculated reliability value is preferably ascertained for each candidate on the basis of the isolated reliability values, which calculated reliability value at least takes into account how many candidates with which isolated reliability value were each assigned to a parameter. The candidate with the highest calculated reliability value may then be selected as information suitable for the parameter. There is preferably provision in this case for further factors to be taken into account for ascertaining the calculated reliability values, in addition to the comparison between the expected and actual values based on the rules, that is to say the isolated reliability values. Thus, for example, a lack of assignment of candidates to parameters, the relationship between candidates of different parameters (for example multiple assignment, implicit relationships), a plausibility check on ranges of values, the relationship between the reliability values of two or more candidates of a parameter and the like may be taken into account.

By calculating the calculated reliability value on the basis of the isolated reliability value, the method is able to reliably make decisions for follow-up actions, such as for example requesting a user check, no follow-up action, or initiating further steps. This calculated reliability value is thus a reliable indicator as to whether the document content relevant to the method was or was not able to be acquired with good quality. The level of the reliability value may then be used to control the further method flow; for example to request a check by a user if threshold values are dropped below.

In general, in the case of a reliability value above a threshold value, the assignment is assumed to be correct, whereas, in the case of a reliability value below a threshold value, a user inspection or input is requested.

There is preferably provision, for example taking into account the increasing performance of processing systems that allow a change from strictly sequential, target-oriented processing to parallel processing of possible solution options, to successively increase the proportion of documents containing parameters identified as completely as possible with high reliability. “Parallel processing” means here that multiple general and/or specific document types are applied in parallel for a submitted document, and the document type used for the further process is then also selected on the basis of a comparison between the reliability values achieved in each case.

Preferably, the general policy is applied and the isolated reliability values are ascertained after the general document type has been selected, wherein a user check or input is requested in particular in the case of at least one low isolated reliability value, and, after the user check has been completed, specific rules for acquiring and assigning this information from the document are created and a specific document type is generated that modifies the general rules that have already been met in such a way that they represent the submitted document in a much more precise manner. Similar documents, for example using an identical format template, may thus be processed with higher reliability in the future.

The correct assignment of information to parameters by the system also leads to adaptation of the specific rules or the expected (ranges of) values, which may for example be defined more narrowly. If information is assigned manually to a parameter by the user, the system then attempts to ascertain this information from the document and draws up specific rules for the future acquisition and assignment of this information. If the manually input information is not able to be found in the document, a user request may for example be made and this information may be assigned to the document type as quasi-static information. This information may thus be extracted from subsequent documents of this specific document type even without the help of the user.

It is preferred for the specific policy to be applied and the isolated reliability values to be ascertained after the specific document type has been ascertained, wherein a user check is requested in the case of at least one low calculated reliability value, and, after the user check has been completed, specific rules for acquiring and assigning this information from the document are created or modified and a new or modified specific document type is generated therefrom in the case of low reliability values. As in the case of the selection of a general document type as well, when a specific document type is used, the rules, in this case the specific rules, are adapted in order to further improve the accuracy of the content acquisition in the future.

There is in particular provision in this case, in addition to the parameters proposed by the specific document type, for further parameters to be created by the user and information to be assigned thereto, wherein specific rules for acquiring and assigning this information in the document are created or modified therefrom and a new or modified specific document type is generated therefrom. The method is thus not static, but rather may be expanded by the user as desired. By specifying further parameters, the acquired document content or the document content to be acquired may be variably adapted to the needs of the user, wherein such additional parameters may also be ascertained retrospectively for already processed documents with an identical or specific document type and the values may be assigned. These additional parameters may also possibly be made available to other users. The system thus “learns” from individual users and makes this “knowledge” available to other users.

In one preferred development, a follow-up action may be proposed or carried out on the basis of the selected document type, the identified parameters and the reliability values. The method according to the invention may thus initiate a targeted follow-up action on the basis of the document content, for example preparing a payment, noting a deadline or erasing data.

The generic rules for determining the general or specific document type preferably comprise a keyword search on the basis of stored keywords, keyword combinations or any other properties of a document that unambiguously define a document type. Such properties may be for example the appearance of the terms invoice, delivery note, certificate and the like. This may however in principle be any part or property of a document. On the basis of such predefined characteristics typical for each general document type, it is possible to assign even previously completely unknown documents to a known general document type or even to create new general document types on the basis of user information.

Information for the parameters from the group language, keywords, currency, amount, timestamp/date, categorizations, key numbers, status, the referencing of external data, file size and other information relevant to the method is preferably assigned to general rules associated with the selected general document type. This means that the most important information for the respective document type may often already be acquired without having to resort to specific rules. By way of example, the currency in the case of an invoice, and often also the invoice amount, may thus already be acquired on the basis of general rules. If a document is processed in accordance with a general document type, including possible user checks/inputs, a precedent has thus been acquired and a suitable specific document type is created for this document.

When processing a document of a specific document type, the information relevant to the method is preferably assigned to the individual parameters on the basis of the associated specific rules. Specific parameters are in particular information relevant to the method from the group language, keywords, currency, amount (gross, net, sales amount, inventory), timestamp/date (for example dispatch date, notice period, etc.), categorizations, key numbers, status, the referencing of external data or else physical document properties. The isolated reliability value is calculated by comparing expected values with the actually ascertained values, as described above.

It is particularly preferred in this case for the general and/or specific rules to assign properties to the parameters. These rules may in this case each include a large number of individual rules for in each case one parameter. The properties may in this case for example represent a position in the document, formatting, frequencies, expected values and ranges of values and a direct relationship to other parameters or candidates, ability to reference keywords, ability to reference external databases and/or the respective tolerable deviations. Any other properties may likewise be used if necessary, for example color differences, physical properties and the like. The rules thus define properties for the candidates, that is to say the parts of the document that contain the information relevant to the method. To calculate the reliability values, different rules and properties may in this case be assigned specific values.

It is preferred in this case for the fact that the respective candidates meet the properties to serve to calculate the isolated and thus also the calculated reliability value. A candidate may therefore represent the desired information even if it does not meet all of the properties defined by the rules. This guarantees a relatively high level of fault tolerance, and information is acquired reliably.

In one preferred development, specific document types and the specific rules are exchanged between different users. This makes use of the fact that, in the case of a large number of users, a large number of documents are also read in and specific document types are created for this purpose, such that specific document types are available for a large number of documents after a relatively short time, these comprising corresponding specific rules that allow reliable high-quality content acquisition from the documents.

The method according to the invention is described in more detail below with reference to one preferred exemplary embodiment in conjunction with the drawings. In this case, in each case schematically:

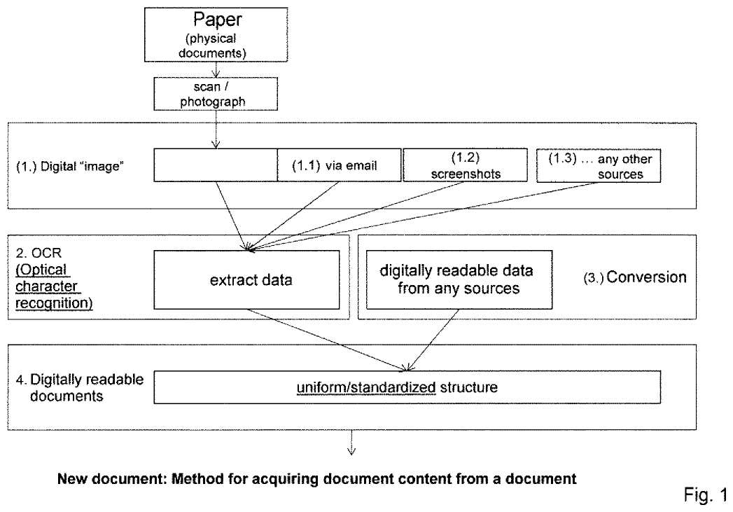

FIG. 1 shows a sequence for supplying documents,

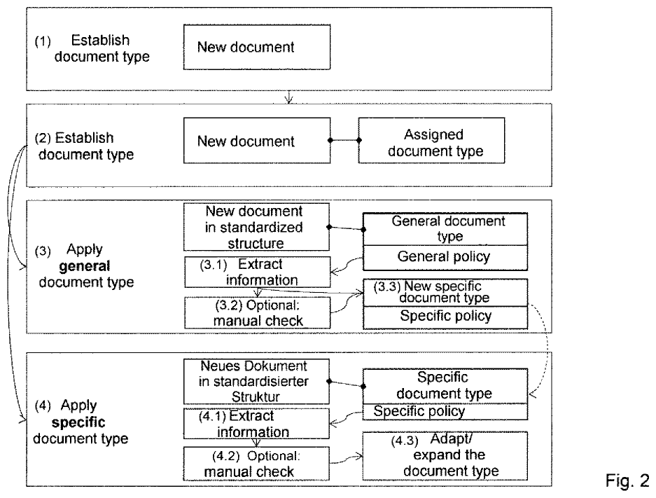

FIG. 2 shows a sequence of the method according to the invention, and

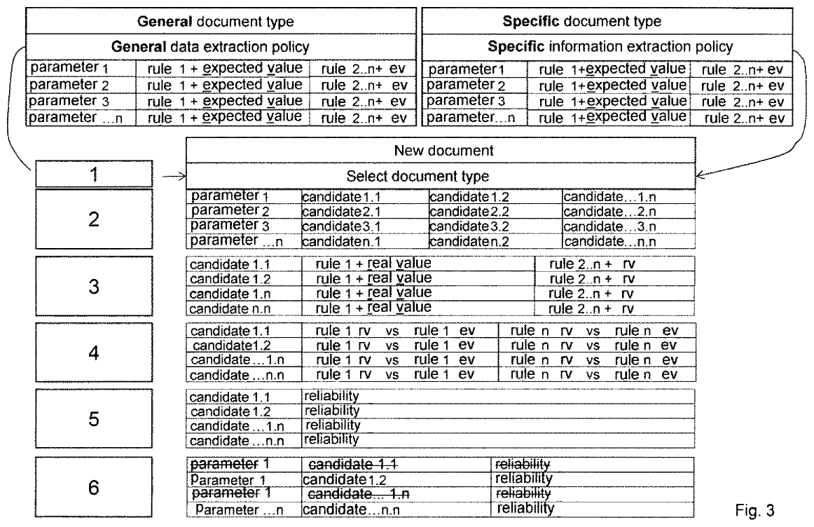

FIG. 3 shows an example for extracting and assigning information.

FIG. 1 illustrates a typical sequence for supplying documents. If the document whose content is to be acquired is a physical document, for example made of paper, a digital image is generated therefrom in a first step through scanning or photography and is stored in a corresponding format such as JPG, TIFF, GIF, PDF or the like.

The digital image thus generated is then treated in the same way as any other electronic document. Electronic documents may in this case be transmitted via e-mail or be an e-mail themselves, but they may also be screenshots and the like.

These electronic documents are then converted or reformatted. Text recognition (OCR), extraction of data such as for example text, characters, graphical elements or even physical properties of the document are for example performed in this case in order to achieve electronic readability that is as comprehensive as possible.

These readable and evaluable documents are then stored in a standardized structure and further processed in the computer-implemented method according to the invention for acquiring document content.

As illustrated in FIG. 2, the new document in its standardized structure is first assigned to a document type. To this end, generic rules are applied that also allow unknown documents to be assigned to predefined document types, such as invoice or delivery note. In this case, there is in particular a general document type that is used when no assignment is possible. Such generic rules are based for example on the search for keywords in the document that are characteristic of a document type.

It is then checked whether a precedent already exists, that is to say a document that is at least similar in terms of form, for example using identical forms/format templates. If this is the case, the specific document type with the associated specific rules is used in the rest of the method, and if not the general document type with its general rules is used.

Information from the document is then ascertained from the document by applying the general or specific rules and assigned to parameters. By way of example, a number from the document is assigned to the parameter invoice amount. Another rule then states for example that this number represents the invoice amount if it is the highest amount from the document. Multiple rules thus usually belong to each desired parameter, wherein a high reliability value is obtained if an item of information corresponds to a large number of these rules, and the information found is thus likely to represent the correct information for this parameter.

After the document has been searched for suitable candidates for all parameters and the information has been assigned to the parameters, a modified or new specific document type is generated that comprises specific rules in order to be able to directly use a suitable specific document type when a document originating from the same format template is read in again, which document type allows high-quality content acquisition.

The extraction of information and its assignment to a parameter is illustrated in FIG. 3. Multiple parameters 1-n must be filled with information from the document both in the case of a general document type and in the case of a specific document type. To this end, multiple rules, in which properties are in turn assigned to the expected values, are assigned to each parameter.

For each parameter, taking into account the rules, multiple candidates that may represent the desired information are found in the document. The further procedure will now be explained on the basis of the candidates 1.1 to 1.n found for parameter 1.

For each candidate, the extent to which it meets the corresponding rule and has the expected properties is checked. The results thereby obtained initially give an isolated reliability value. These isolated reliability values are then correlated with one another and, if necessary, further factors are taken into account, then giving a calculated reliability value for each candidate.

The candidate with the greatest calculated reliability value then represents the information sought for the parameter.

The same procedure is then followed for all of the other parameters until information is also assigned thereto. Further follow-up actions may then depend on the information actually received, but also on the associated reliability values.

The typical sequence of the method according to the invention is as follows:

After selecting the document type, for example the invoice type, it is checked whether a specific document type is available with respect thereto, for example invoice from A. This specific document type is then selected and the candidates that could represent the desired information for the parameters are ascertained from the document. By applying the rules, isolated reliability values and then calculated reliability values are then calculated for each candidate. The candidate with the highest reliability value is then considered to be the sought information.

The document may in this case also be rated, that is to say as to how well the individual rules have been met and the information has been assigned to the parameters, on the basis of the calculated reliability values. If necessary, the specific rules are also adapted further or a new, specific document type is created.

The method according to the invention may therefore already yield valuable and quality-controlled results for the user for an unknown document of a previously unknown source and/or type. Future improvements to the rules by processing further documents similar in terms of form may be transferred to all relevant documents. A controlled and consistent processing quality is thus achieved for all documents similar in this respect. A lengthy, preliminary statistical evaluation, which requires a relatively large amount of memory space and computing power, is accordingly not necessary. By contrast, document content is acquired on the basis of a few generic rules belonging to the document type ascertained therefrom, which lead to good acquisition of the document content even for unknown documents. By acquiring the document content, the storage requirement may in this case be reduced, since only the desired information and parameters are stored, but not necessarily the entire document. The document content may then also be retrieved more easily, for example by searching for individual parameters or information.

1. A computer-implemented method for acquiring document content from a document, which method, on the basis of generic rules, acquires information from the document and assigns it to parameters and ascertains a general document type or specific document type on this basis, wherein the general document type has general rules for assigning further information to parameters and the specific document type provides specific rules for ascertaining and assigning further information to parameters, wherein the general document type is selected if no suitable specific document type is able to be ascertained, wherein the respective assignment of information to a parameter is given a calculated and/or isolated reliability value.

2. The method as claimed in claim 1, characterized in that the information is ascertained from one or more candidates identified in the document, wherein an isolated reliability value for each candidate is ascertained on the basis of the general and/or specific rules.

3. The method as claimed in claim 2, characterized in that a calculated reliability value is ascertained for each candidate on the basis of the isolated reliability values, which calculated reliability value at least takes into account which further candidates with which isolated reliability values were each assigned to a parameter, wherein the candidate with the highest calculated reliability value may be selected as information suitable for the parameter.

4. The method as claimed in claim 3, characterized in that a common calculated reliability value for a document is ascertained on the basis of the calculated reliability values of the candidates selected for the parameters.

5. The method as claimed in claim 3, characterized in that the general policy is applied and the calculated reliability values are ascertained after the general document type has been selected and the candidates for the sought information have been ascertained, wherein a user check is requested in the case of at least one low calculated reliability value, and, after the user check has been completed, specific rules for acquiring and assigning this information from the document are created in an automated manner and a specific document type is generated.

6. The method as claimed in claim 5, characterized in that, in the case of exclusively high calculated reliability values, a specific document type with specific rules is generated on the basis of the assignments made.

7. The method as claimed in claim 1, characterized in that the specific policy is applied and the calculated reliability values are ascertained after the specific document type has been ascertained, wherein a user check is requested in the case of at least one low calculated reliability value, and, after the user check has been completed, specific rules for acquiring and assigning this information from the document are created or modified and a new or modified specific document type is generated therefrom in the case of low reliability values.

8. The method as claimed in claim 7, characterized in that, in addition to the parameters proposed by the specific document type, further parameters are created by the user and information is assigned thereto, wherein specific rules for acquiring and assigning this information from the document are created or modified therefrom and a new or modified specific document type is generated therefrom.

9. The method as claimed in claim 1, characterized in that a follow-up action is proposed or carried out on the basis of the selected document type and the reliability values.

10. The method as claimed in claim 1, characterized in that the generic rules for determining the document type comprise format checks, logic checks, user-specific historical information and/or a keyword search based on stored keywords or keyword combinations that define a document type.

11. The method as claimed in claim 1, characterized in that information is assigned to the parameters from the group language, keywords, currency, amount, status on the basis of the general rules belonging to the selected general document type.

12. The method as claimed in claim 1, characterized in that information is assigned to the parameters from the group dispatch date, payment term, name, keywords, language, amounts, status, referencing on the basis of specific rules.

13. The method as claimed in claim 1, characterized in that the general and/or specific rules assign properties to the parameters, wherein the properties are selected from the group comprising positions, formatting, format, frequencies, expected values, implicit relationships with other information in the document, relationships with external references to information in the document and/or tolerable deviations.

14. The method as claimed in claim 13, characterized in that the fact that the respective candidates meet the properties serves to calculate a reliability value.

15. The method as claimed in claim 1, characterized in that general and/or specific document types and the associated rules may be exchanged between different users.
